(19) United States
(12) Patent Application Publication
(10) Pub. No.: US 2014/0028183 A1
(43) Pub. Date: Jan. 30, 2014

(54) High-pressure discharge lamp

(71) Applicant: OSRAM GmbH, Muenchen (DE)

(72) Inventors: Thomas Hartmann, Berlin (DE); Matthias Lenz, Falkensee (DE); Thomas Wichmann, Berlin (DE)

(21) Appl. No.: 13/945,981

(22) Filed: Jul. 19, 2013

(30) Foreign Application Priority Data
Jul. 26, 2012 (DE) 10 2012 213 191.4

(51) Int. Cl. H01J 61/073

(52) U.S. Cl. CPC H01J 61/0732
USPC 313/608

(57) ABSTRACT

Various embodiments provide a high-pressure discharge lamp. The high-pressure discharge lamp may include a discharge vessel; and an electrode, which is secured in one end of the discharge vessel, the electrode having a stem designed as an elongated pin-shaped body, the electrode being part of an electrode system that also comprises a lead-through, with the aid of which the end of the discharge vessel is sealed in a gas-tight manner; wherein at least the stem includes an electrically conductive ceramic boride of a metal that comprises at least lanthanum, cerium, yttrium or ytterbium, alone or in combination.

### CROSS-REFERENCE TO RELATED APPLICATION

This application claims priority to German Patent Application Serial No. 10 2012 213 191.4, which was filed Jul. 26, 2012, and is incorporated herein by reference in its entirety.

### TECHNICAL FIELD

Various embodiments relate generally to a high-pressure discharge lamp.

### BACKGROUND

WO 2010/069678 discloses a ceramic electrode, which is designed as a series of layers and is made from LaB₆ or CeB₆. Such a layered electrode is laboriously produced by means of dry pressing, an injection-molding process or multi-layer technology.

In WO 2011/085839, the basic use of ceramic electrodes for high-pressure lamps is described. For this, the head, or a region of the head, is produced from ceramic material of the boride type. So far there has not been any suitable technical implementation of ceramic electrodes in high-pressure discharge lamps.

### SUMMARY

Various embodiments provide a high-pressure discharge lamp. The high-pressure discharge lamp may include a discharge vessel; and an electrode, which is secured in one end of the discharge vessel, the electrode having a stem designed as an elongated pin-shaped body, the electrode being part of an electrode system that also comprises a lead-through, with the aid of which the end of the discharge vessel is sealed in a gas-tight manner; wherein at least the stem comprises an electrically conductive ceramic boride of a metal that comprises at least lanthanum, cerium, yttrium or ytterbium, alone or in combination.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 schematically shows a metal-halide lamp;

FIG. 2 shows an embodiment of the end region;

FIG. 3 shows a further embodiment of the design of an end region;

FIG. 4 shows a further embodiment of the design of an end region;

FIG. 5 shows a further embodiment of the design of an end region; and

FIG. 6 shows a further embodiment of the design of an end region.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

Various embodiments provide a high-pressure discharge lamp which makes it possible to achieve a long service life for such lamps by using a ceramic body, which has a high resistance to corrosive filling and to erosion and in which the ceramic body e.g. has a coefficient of thermal expansion that is adapted well to a ceramic discharge vessel, and consequently improves the sealing.

Various embodiments of the high-pressure discharge lamp have an electrode, which is designed as a pin-shaped ceramic body which includes a boride of a rare earth metal, selected from lanthanum, cerium, yttrium and ytterbium. In various embodiments, the electrode and the lead-through may be designed as an integral combined part.

Various embodiments of the electrode have at least one stem of ceramic, which is designed as a pin. Used as the ceramic material is a boride of lanthanum, cerium, yttrium or ytterbium, alone or as a mixture. Such compounds have the chemical formula MB₆, where M is at least one of the rare earth metals mentioned.

The electrode is generally simply a pin of a constant diameter. However, it may also be of a different form, for example flattened. A head may also be mounted in the front region of the electrode that is facing the discharge. In various embodiments, such a head may also be produced on such a ceramic material. In various embodiments, LaB₆ may be used for this.

In various embodiments, the pin is made sufficiently long for a front portion to be able to perform the task of the stem and a rear portion to be able at the same time to perform the task of a lead-through.

Such elongated pins combine the advantages pertaining to electrodes and a lead-through as a single component that is ceramic throughout. The two main advantages of such materials are favorable, well-adapted thermal expansion characteristics and the low electron work function of such materials, which can consequently be used simultaneously.

Used e.g. as a novel material for the stem or the combined stem/lead-through part is a ceramic composite on the basis of LaB₆. LaB₆ has a work function of 2.14 eV and an electrical resistance of 15 μohm-cm. The coefficient of thermal expansion α is 6.2*10⁻⁶K⁻¹. It is consequently less than the coefficient of expansion of pure PCA, which is α=8.3*10⁻⁶K⁻¹. The most important properties of LaB₆ are compared with those of tungsten, see Table 1.

TABLE 1

| | | |
|---|---|---|
| Material | Tungsten | LaB₆ |
| Melting temperature | 3600° C. | 2528 K |
| Work function | 4.55 eV | 2.14 eV |
| Thermal conductivity | 170 W/mK | 47 W/mK |
| Coefficient of thermal | 4.7 × 10⁻⁶/K | 6.2 × 10⁻⁶/K |
| expansion | | |

The particular advantage of the aforementioned ceramic materials is the combination of:

1) the favorable thermal expansion, which may make it possible for the electrode system to be embedded in the discharge vessel in a largely stress-free and gas-tight manner, and

2) the low electron work function, with resultant low electrode temperatures.

This may make a much simpler electrode design possible than the solutions conventionally used, in that the typically different materials for the electrode and the lead-through can now be replaced by a one-part component of the same material.

However, the ceramic materials that are used differ considerably in their processability from the materials that are otherwise used.

Thus, in various embodiments, the conventional methods for contacting the electrode/electrode system to the electrical supply lead or the lamp frame cannot be used. Used instead are novel connection techniques, which ensure a suitable electrical, thermal and mechanical contact between the ceramic electrode system and the metallic power supply lead/lamp frame.

Advantages of this are, in various embodiments:
the drastic simplification of the electrode system, e.g. since it is possible to dispense with a head of the electrode and a separate lead-through;
the use of ceramic, electrically conductive materials with low work function;
the lowering of the operating temperature of the electrode tip from 3200 K to only 1800 to 2000 K, which may have a strong influence on the blackening characteristics, and consequently the service life,
the thermal conductivity of LaB₆ is much lower than that of tungsten; this results in a much lower transfer of heat to the surroundings of the lamp, e.g. to the critical zones of the electrode lead-through;
the good adaptation of the coefficient of thermal expansion of the lead-through to the ceramic discharge vessel;
the material of the lead-through and of the electrode as a whole is directly compatible with the material of the discharge vessel, which produces an improved connection between the electrode and the discharge vessel in the sense of better mechanical stability and a more compact structural form and;
the longer service life (at least 20%, depending on the embodiment up to 100%), since a main cause of failure, the leakage in the region of the capillaries of the electrode lead-throughs, can be made more robust;
the higher energy efficiency, since the electrodes are operated at a lower temperature, and thus have lower thermal losses.

The described technical embodiments of electrode systems on the basis of ceramic components may allow the large-scale production of high-pressure discharge lamps with the advantages of a low electron work function and favorable thermal expansion.

The about 2 eV lower work function of materials such as LaB₆ as compared with tungsten leads to an experimentally determined lowering of the temperature at the tip of the electrode of approximately 1300 K as compared with tungsten, for which the typical value is 3100 K.

On account of the lower thermal conductivity and the lower operating temperature, this may lead to much lower thermal losses, which is synonymous with higher efficiency. This in turn may have the consequence that the energy input into the lead-through is reduced.

The lower working temperature or operating temperature and the fact that LaB₆ has a much higher coefficient of thermal expansion than tungsten, which is much closer to that of Al₂O₃, e.g. PCA, gives rise to the possibility of a much shorter overall length of the lamp, because the capillaries can be reduced in their length. A further associated positive effect may result in a reduced volume of dead space.

This in turn may lead to lower color dispersion and a longer service life.

A construction that is almost completely without any capillary dead space is also possible, which for the first time allows an unsaturated filling to be used for the discharge vessel, with all its advantages, such as for example dimmability.

Added to this is that a material such as LaB₆ is corrosion-resistant to rare-earth iodides as a constituent of the filling. As a result, the service life is increased further.

Overall, there are therefore advantages as a result of the lower operating temperature, reduced thermal losses, higher efficiency, saving of electrical energy, low color dispersion, greater reliability, high resistance to corrosion.

In various embodiments, a filling that is free from mercury may be used.

Various features of various embodiments in the form of an enumeration are:

1. A high-pressure discharge lamp with a discharge vessel and an electrode, which is secured in one end of the discharge vessel, the electrode having a stem designed as an elongated pin-shaped body, the electrode being part of an electrode system that also comprises a lead-through, with the aid of which the end of the discharge vessel is sealed in a gas-tight manner, wherein at least the stem includes an electrically conductive ceramic boride of a metal that comprises at least lanthanum, cerium, yttrium or ytterbium, alone or in combination.

2. The high-pressure discharge lamp as described unter item 1, wherein the pin-shaped stem is cylindrical or flattened.

3. The high-pressure discharge lamp as described unter item 1, wherein a front portion of the pin-shaped body acts as a stem and a rear portion attached integrally thereto acts as a lead-through.

4. The high-pressure discharge lamp as described unter item 3, wherein the lead-through is sealed off by means of glass solder in the end.

5. The high-pressure discharge lamp as described unter item 1 or 3, wherein the pin-shaped body is connected to an electrically conducting connection part by means of butt welding and/or by way of a connecting sleeve.

6. The high-pressure discharge lamp as described unter item 5, wherein the connection part is a power supply lead, a frame part or a sleeve with a bush.

7. The high-pressure discharge lamp as described unter item 1 or 3, wherein the discharge vessel is produced from ceramic material, e.g. Al₂O₃ or Y₂Al₅O₁₂ or AlN.

8. The high-pressure discharge lamp as described unter item 1 or 3, wherein the discharge vessel is produced from PCA.

9. The high-pressure discharge lamp as described unter item 1 or 3, wherein the discharge vessel is produced from quartz glass.

10. The high-pressure discharge lamp as described unter item 9, wherein the discharge vessel is closed by means of a pinch seal, there being embedded in the end of the discharge vessel a connecting sleeve or a connecting coil, which ensures the connection of the body to a connection part.

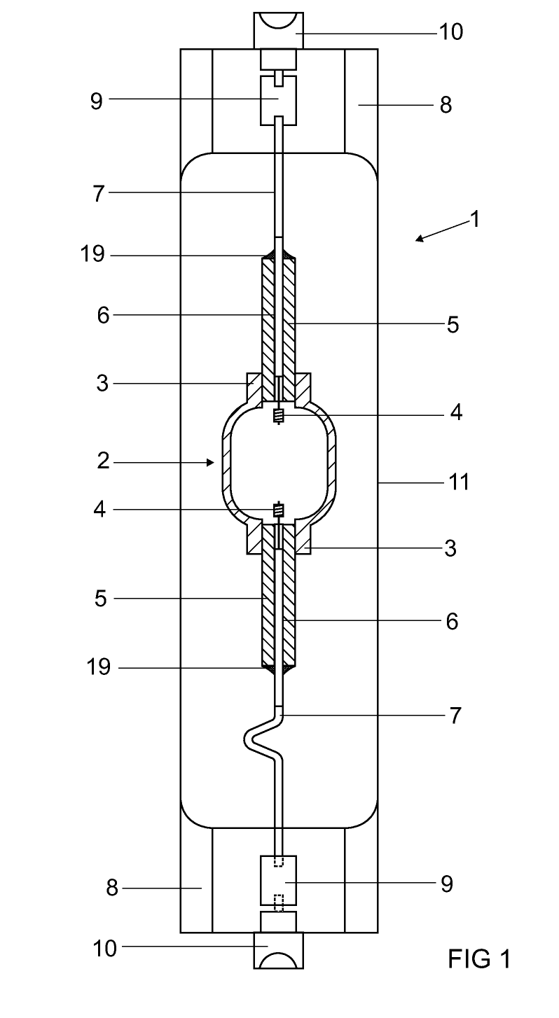

FIG. 1 shows an embodiment of a metal-halide high-pressure discharge lamp 1. It has a ceramic discharge vessel 2, which is closed on two sides. It is elongated and has two ends 3 with seals. Inside the discharge vessel there are two electrodes 4 opposite each other. The seals are designed as capillaries, in which a lead-through 6 is respectively sealed off by means of glass solder 19 (schematically represented). The end of the lead-through 6 respectively protrudes outward from the capillary 5. The lead-through is connected on the discharge side to the assigned electrode 4 in a known way. It is connected by way of a power supply lead 7 and a pinch seal 8 with foil 9 to a base contact 10. The contact 10 is located at the end of an outer bulb 11 surrounding the discharge vessel.

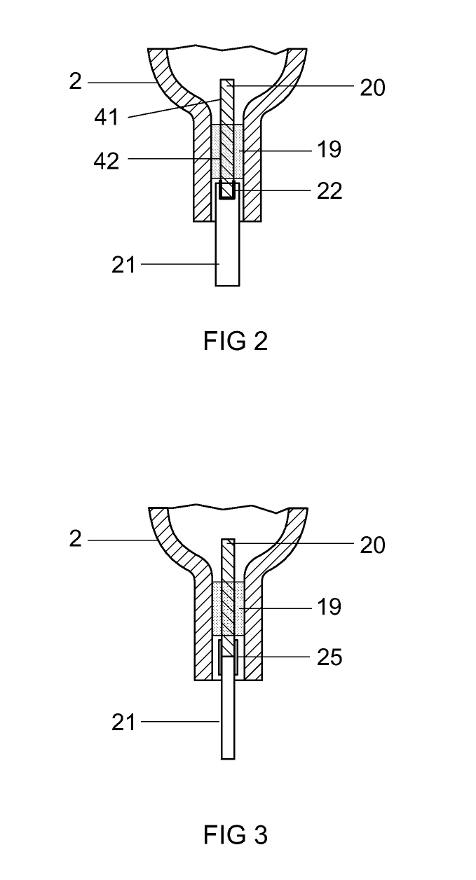

FIG. 2 shows as the end of the discharge vessel a capillary 5, into which a pin-shaped electrode of lanthanum hexaboride (LaB₆) is inserted. In this case, a front portion 41 of the pin 20 of lanthanum hexaboride (LaB₆) assumes the function of the electrode, e.g. the stem of the electrode, while a rear portion 42 of the pin 20 assumes the function of the lead-through from the ceramic discharge vessel. It is therefore a pin that is sufficiently long to protrude with its front portion into the discharge volume and at the same time to fill with its rear portion a considerable part of the capillary. Generally, the rear portion of the pin should fill at least 50% of the axial length of the capillary. The largely stress-free and gas-tight embedding takes place in a known way by a glass solder 19, which encloses a significant part of the rear portion in a sealing manner.

The pin 20 may in this case be understood as an elongated component with a geometry that is not defined any more specifically; it may in various embodiments be a cylindrical pin or else a flattened pin.

The rear portion of the ceramic electrode is connected to a metallic outer power supply lead 21 or a component of the lamp frame. To ensure the electrical, thermal and mechanical contact, the connection takes place by inserting or else press-fitting the rear portion into a bore 22, as already known in principle from DE 102 56 389 and German utility model DE 20 2004 013 922, or by laser welding. For press-fitting, the rear portion may possibly have a projecting stub with a reduced diameter.

In various embodiments, a laser welding connects the rear portion of the ceramic pin to the metallic power supply lead, the cross sections of the pin and the power supply lead not having to be uniform. The laser welding is performed with preference as butt welding. The reliable connection of the materials of the pin and the power supply lead is based in this case on the melting and penetration of the molten metal of the power supply lead in the layers near the surface of the ceramic of the pin.

If a bore 22 for receiving the ceramic electrode is incorporated in a correspondingly larger cross section of the power supply lead, as represented in FIG. 2, a combination of insertion/press-fitting and additional welding of the materials by means of the aforementioned laser welding may also be used.

The resultant region of a connection between the pin and the power supply lead may be both positioned outside the ceramic discharge vessel and arranged within a capillary at the end of the discharge vessel of ceramic (as represented in FIG. 2).

The embedding and sealing of the electrode system in the capillary of the ceramic discharge vessel takes place by means of glass solder, the glass solder being used in various embodiments level with the ceramic electrode. The region of the embedding may, however, likewise include the connecting point between the ceramic pin and the power supply lead or lamp frame.

FIG. 3 likewise shows a ceramic pin 20, which simultaneously performs the function of the electrode and the lead-through in a ceramic discharge vessel 2. The connection between the pin 20 and the metallic power supply lead 21 (or lamp frame) is created here by a metallic sleeve 25, for example of Nb or Nb/Zr, which receives the ends of the two components 20 and 21 to be connected. The sleeve 25 and the power supply lead 21 or lamp frame are typically welded, but may also be fixed by insertion/press-fitting, as already described above. The connection of the sleeve 25 to the ceramic electrode may take place by simple insertion/press-fitting, or else be improved by laser welding, melting of the metal and penetration of the then molten metal in layers near the surface of the ceramic pin 20 taking place here.

Here, too, the largely stress-free and gas-tight embedding and sealing also takes place by a glass solder 19 within the ceramic capillary. Again, the connecting point in the region of the sleeve 25 may also be positioned outside the capillary, and be embedded there in glass solder.

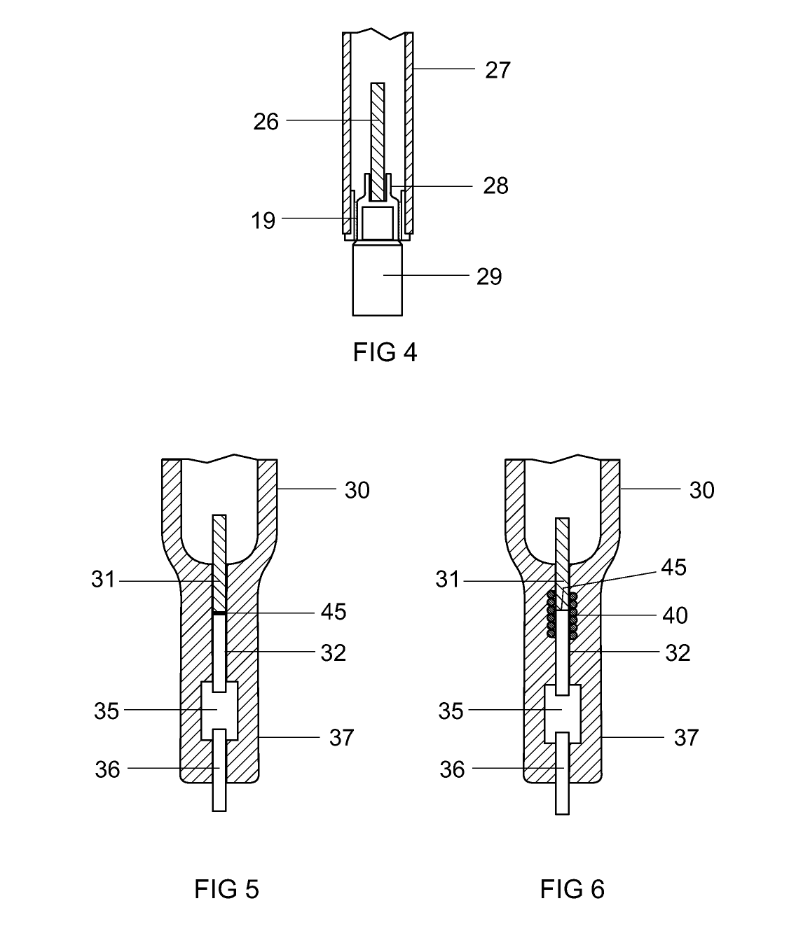

FIG. 4 shows a further embodiment of a pin-shaped ceramic electrode 26 in a ceramic discharge vessel 27. This is a cylindrical ceramic discharge vessel with a high aspect ratio and constant diameter even at the ends, as is typical of sodium high-pressure lamps. A metallic sleeve 29 with a bush 28, receiving the pin 26 and pointing inward, is shaped here in such a way that the bush 28 receives the ceramic electrode 26. On the side wall of the sleeve, the gas-tight connection to the end of the discharge vessel 27 is ensured by means of glass solder 19.

In this embodiment it is not important that the coefficient of thermal expansion of the pin and the discharge vessel, mostly PCA, are made to match each other.

FIG. 5 shows the use of ceramic electrodes in high-pressure discharge lamps with a discharge vessel 30 of quartz glass. The ceramic electrode 31 is connected here by butt welding to a metallic power supply lead 32, in particular of Nb or Nb/Zr.

Alternatively, the connection techniques according to FIG. 3 and FIG. 4 are also possible. The gas-tight closing of the end of the discharge vessel takes place in the case of a vessel 30 of quartz glass by softening and pinching the outer end of the discharge vessel. In this case, the connecting point 45 between the ceramic electrode and the power supply lead may be embedded into the pinch seal 37 or reach into the discharge space.

The occurrence of critical thermal stresses between the electrode system and the quartz glass burner is avoided in a known way by use of a molybdenum foil 35. With respect to the connecting point 45 to the electrode, this foil is located behind the latter, and is therefore further away from the discharge volume. Attached to the foil 35 on the outside in a known way is a supply lead 36, which protrudes from the pinch seal 37. FIG. 6 shows a further embodiment of a sealing of a discharge vessel 30 of quartz glass, the ceramic electrode 31 being bonded in butt contact with the metallic power supply lead 32. Used here as the means of connection between the power supply lead and the electrode is a coil 40 of tungsten, the inside diameter of which is chosen such that both the ceramic electrode pin 31 and the power supply lead 32 can be precisely fitted into it.

The occurrence of critical thermal stresses between the electrode system and the quartz glass burner is again avoided in a known way by using a molybdenum foil 35. With respect to the connecting point 45, this foil is located behind the latter, and is therefore away from the discharge volume.

The electrode system represented here is well suited both for discharge vessels of Al₂O₃, specifically PCA, and for those of quartz glass. The electrode in accordance with various embodiments may also be used for discharge vessels of other materials, such as e.g. AlN, AlON or Y₂O₃. The use of mixtures of LaB₆/AlN, LaB₆/AlON or LaB₆/Y₂O₃ is recommendable here for the electrode. In various embodiments, the proportion of the conductive LaB₆ should in each case lie above the percolation limit.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A high-pressure discharge lamp, comprising:
a discharge vessel; and
an electrode, which is secured in one end of the discharge vessel, the electrode having a stem designed as an elongated pin-shaped body, the electrode being part of an electrode system that also comprises a lead-through, with the aid of which the end of the discharge vessel is sealed in a gas-tight manner;
wherein at least the stem comprises an electrically conductive ceramic boride of a metal that comprises at least lanthanum, cerium, yttrium or ytterbium, alone or in combination.

2. The high-pressure discharge lamp of claim 1,
wherein the pin-shaped stem is cylindrical or flattened.

3. The high-pressure discharge lamp of claim 1,
wherein a front portion of the pin-shaped body acts as a stem and a rear portion attached integrally thereto acts as a lead-through.

4. The high-pressure discharge lamp of claim 3,
wherein the lead-through is sealed off by means of glass solder in the end.

5. The high-pressure discharge lamp of claim 1,
wherein the pin-shaped body is connected to an electrically conducting connection part at least one of by means of butt welding and by way of a connecting sleeve.

6. The high-pressure discharge lamp of claim 5,
wherein the connection part is a power supply lead, a frame part or a sleeve with a bush.

7. The high-pressure discharge lamp of claim 1,
wherein the discharge vessel is produced from ceramic material.

8. The high-pressure discharge lamp of claim 7,
wherein the discharge vessel is produced from Al₂O₃ or Y₂Al₅O₁₂ or AlN.

9. The high-pressure discharge lamp of claim 1,
wherein the discharge vessel is produced from PCA.

10. The high-pressure discharge lamp of claim 1,
wherein the discharge vessel is produced from quartz glass.

11. The high-pressure discharge lamp of claim 10,
wherein the discharge vessel is closed by means of a pinch seal, there being embedded in the end of the discharge vessel a connecting sleeve or a connecting coil, which ensures the connection of the body to a connection part.
